(19) United States
(12) Patent Application Publication
(10) Pub. No.: US 2003/0005041 A1
(43) Pub. Date: Jan. 2, 2003

(54) World wide web document distribution system with user selective accessing of any one of a stored historical sequence of changed versions of a bookmarked web document

(75) Inventors: Cristi Nesbitt Ullmann, Austin, TX (US); Lorin Evan Ullmann, Austin, TX (US)

Correspondence Address: Leslie A. Van Leeuwen, International Business Machines Corporation, Intellectual Property Law Department, Burnet Road, Austin, TX, 78758, US

(73) Assignee: International Business Machines Corporation, Armonk, NY

(21) Appl. No.: 09/895,974

(22) Filed: Jun. 29, 2001

(51) Int. Cl. G06F 15/16; G06F 15/173

(52) U.S. Cl. 709/203; 709/238

(57) ABSTRACT

Providing the user with a complete historical sequence of changed versions of a bookmarked Web document at any time that the user needs and, thus, requests the bookmarked Web document. A combination of bookmarking a received Web document that in turn sets up the tracking for changed versions of the bookmarked document. Also included is an implementation for storing a historical sequence of versions of said bookmarked document that is responsive to a user request at a receiving station for said bookmarked document and enables the user to select any one of said versions of said bookmarked document. When the user bookmarks a Web document, he is preferably enabled, i.e. given the option of conventionally bookmarking without tracking for changed versions or selecting to activate the tracking means. The invention provides for obtaining the changed versions of the bookmarked documents, including versions at changed URLs. A Web server controlled by an Internet service Provider preferably includes tracking for the changed versions and the storing of the sequence of changed versions.

### TECHNICAL FIELD

The present invention relates to computer managed communication networks, such as the World Wide Web (Web), and particularly to ease of use for the interactive user to access data from bookmarked Web documents.

### BACKGROUND OF RELATED ART

The past decade has been marked by a technological revolution driven by the convergence of the data processing industry with the consumer electronics industry. The effect has, in turn, driven technologies which have been known and available but relatively quiescent over the years. A major one of these technologies is the Internet or Web (the two terms are used interchangeably) related distribution of documents, media and programs. The convergence of the electronic entertainment and consumer industries with data processing exponentially accelerated the demand for wide ranging communications distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct links between pages and other documentation on the Web and a variety of related data sources, which were at first text and then evolved into media, i.e. “hypermedia”. This even further exploded the use of the Internet or Web. It was now possible for the Web browser or wanderer to spend literally hours going through document after document and accompanying graphics and media in often less than productive excursions through the Web. A significant source of this drain is in the Web page, the basic document page of the Web. Although many Web pages are professionally designed and, thus, relatively efficient to use, there are still a great many Web pages which are very cumbersome to access and to use, particularly when the user is making in depth searches.

The Web browsers, which have been available for over a decade as a Web document search and access tool, have provided users with the means of bookmarking, i.e. saving the Web path to such documents for future reference. However, bookmarking a document provides little assurance that the information which the user needed in the document will be available in the document when the user accesses the document at a future time or that the path, i.e. URL (Universal Resource Locator), to the document will not have been changed. Some Web pages change at a daily or even hourly rate. It should also be noted that because of the eclectic manner in which many Web pages are managed, there is often no correlation between the significance of the information in the Web document and the quality of administration and maintenance by the hosts or owners of the Web document. Thus, information of even great significance to many may be casually eliminated by an uninformed or disinterested page maintainer.

Thus, it is important that Web document users be kept informed of changes in the documents. There are currently available functions through which a user may request updates on Web pages to be forwarded to him as they occur. While such an approach may be of value for a few Web documents of special interest to the user on which the user needs to be informed on a regular basis, the process is quite awkward for the user who may regularly bookmark dozens or even hundreds of Web documents. The process forces the user to review and make decisions on what to do with the changes at times when he is not involved with the dozens of bookmarked documents or at points when he may no longer have interest in the Web documents.

### SUMMARY OF THE PRESENT INVENTION

The present invention solves the above-mentioned problems by providing the user with a complete historical sequence of changed versions of a bookmarked Web document at any time that the user needs and, thus, requests the bookmarked Web document. The invention uses the combination of means for bookmarking a received Web document and means upon said bookmarking which sets up the tracking for changed versions of the bookmarked document. Also included are means for storing a historical sequence of versions of said bookmarked document, and means, responsive to a user request at a receiving station for said bookmarked document, for enabling said user to select any one of said versions of said bookmarked document. When the user bookmarks a Web document, he is preferably enabled (i.e. given the option of conventionally bookmarking without tracking for changed versions or selecting to activate the tracking means).

Thus, when the user calls for the bookmarked Web document there is displayed a default version, which may be the original bookmarked document or the latest version of said bookmarked document; and means are provided for displaying an index of the other stored versions of said bookmarked document. The invention provides for obtaining the changed versions of the bookmarked documents, even including versions at changed URLs.

The Web network includes a Web server and the Web server preferably includes the means for tracking for the changed versions and the means for storing the sequence of changed versions. In the practice of the invention, the Web server may be conveniently maintained by a Web or Internet Service Provider (ISP) that includes means enabling the user to selectively vary the time intervals at which said changed versions of said bookmarked document are tracked for, as well as means enabling the user to selectively vary the maximum number of said sequence of changed versions of said bookmarked document that are to be stored. The fees which the ISP charges the user may, thus, be varied based upon the time intervals at which said changed versions of said bookmarked document are tracked and upon the maximum number of said sequence of changed versions of said bookmarked document that are to be stored.

Also in the practice of the invention there is provided Web browsing means at said receiving display station that includes the means for bookmarking a received Web document and the means for enabling said user to select any one of said versions of said bookmarked document.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter which is capable of implementing the receiving display station on which the received Web page or Web document may be processed by bookmarking in accordance with the present invention;

FIG. 2 is a generalized diagrammatic view of a Web portion upon which the present invention may be implemented;

FIG. 3 is a diagrammatic illustration of a display screen showing an initial Web document which may be bookmarked in accordance with the present invention;

FIG. 4 is the display screen of FIG. 3 showing the dialog box which appears after the user has selected to bookmark through which the user may select to have the updated versions of the bookmarked Web document saved including the settings for the maximum number of versions to be saved, as well as the frequency at which changed versions are to be requested;

FIG. 5 is a diagrammatic illustration of a display screen showing an index of stored versions of a bookmarked Web document presented to a user requesting a Web document;

FIG. 6 is a diagrammatic illustration of a display screen showing one changed version of the bookmarked document shown in FIG. 3;

FIG. 7 is a diagrammatic illustration of a display screen showing another changed version of the bookmarked document shown in FIG. 3 after the URL of the document has been changed;

FIG. 8 is a general flowchart of a program set up to implement the present invention for the obtaining and storing of bookmarked Web documents;

FIG. 9 is a flowchart of an illustrative run of the program set up in FIG. 8; and

FIG. 10 is a flowchart of an illustrative run of the routine in the tracking and storage of changed versions of bookmarked documents by the ISP Web server.

### DETAILED DESCRIPTION OF THE PREFERRED EMBODIMENT

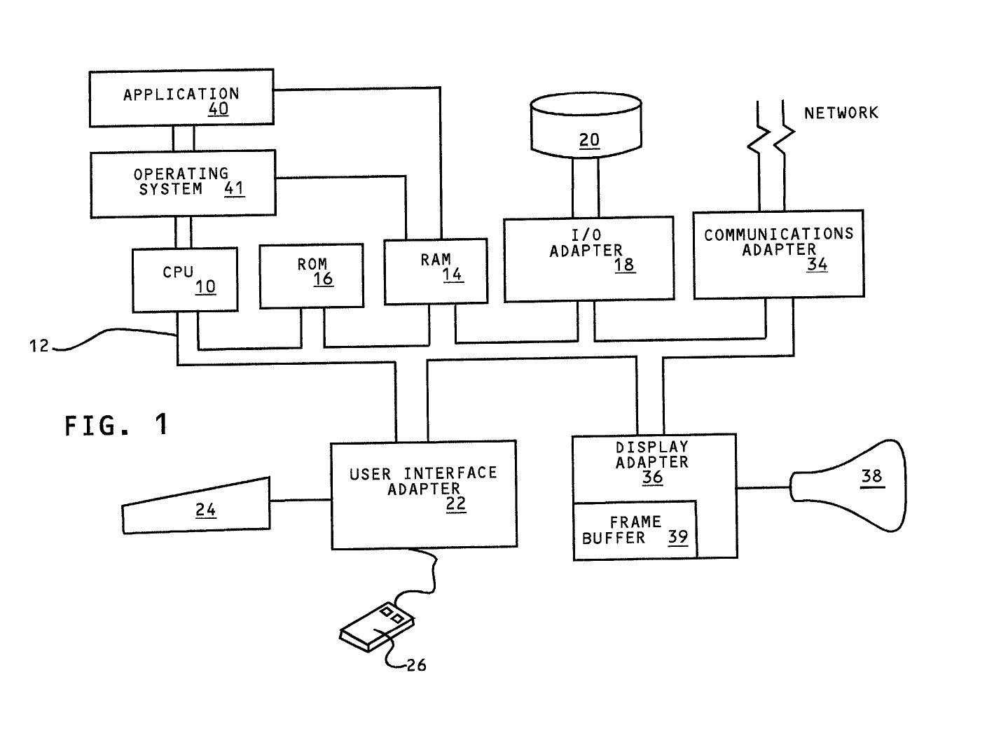

Referring to FIG. 1, a typical data processing terminal is shown that may function as a basic computer controlled Web receiving terminal used in implementing the present invention for the bookmarking of received Web documents, offering the user the option of saving changed versions of bookmarked documents and permitting the user to select to view changed versions of bookmarked documents. The illustrative computer shown may also be used for the ISP Web server used in the practice of the invention. A central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as IBM's AIX 6000™ operating system or Microsoft's Windows98™ or WindowsNT™, as well as UNIX and other IBM AIX operating systems. Application programs 40, controlled by the system, are moved into and out of the main memory Random Access Memory (RAM) 14. These programs include the program of the present invention which will be described hereinafter in combination with any conventional Web browser at the receiving Web station, such as Netscape 3.0™ or Microsoft's Internet Explorer™. Of course, when the illustrative computer of FIG. 1 is performing a Web server function, the program routines in applications 40 would be the programs involved in the tracking and storage of changed versions of bookmarked Web documents. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs for bookmarking and bookmarked version selection at the receiving display terminal according to the present invention. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods which may be related to the present invention. Since a major aspect of the present invention is directed to documents, such as Web pages, transmitted over networks, an understanding of networks and their operating principles would be helpful. We will not go into great detail in describing the networks to which the present invention is applicable. Reference has also been made to the applicability of the present invention to a global network such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such MPEG, JPEG or GIF files, which are described in the text, Internet: The Complete Reference, Millenium Edition, Young et al., 1999, Osborne/McGraw-Hill, particularly at pp. 728-730.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

The invention involves the use of search engines for searching. As described in the above-mentioned Internet: The Complete Reference, Milleniun Edition text, pages 395 and 522-535, search engines use keywords and phrases to query the Web for desired subject matter. Usually the keywords are combined with some of the basic Boolean operators (i.e. AND, OR and NOT) in designing Web queries. Each search engine has its own well developed syntax or rules for combining such Boolean operators with the keywords to conduct the searches. The search engine is a database application that retrieves information according to its own syntax. The search engine usually uses a search agent called a “spider” that looks for information on Web pages. Such information is indexed and stored in a vast database. In carrying out its search, the search engine looks through the database for matches to keywords subject to the engine syntax. The search engine then presents to the user a list of the Web pages it determines to be closest to the requested query. Some significant search engines are: AltaVista, Infoseek, Lycos, Magellan, Webcrawler and Yahoo.

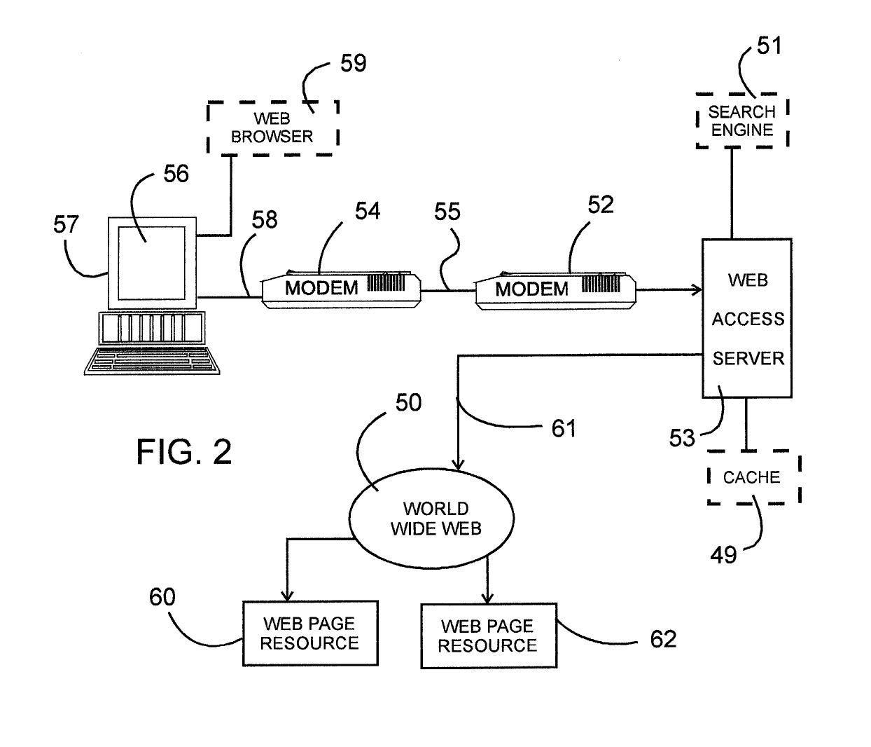

A generalized diagram of a portion of the Web, which the computer controlled display terminal 57 used for Web page receiving during searching or browsing, is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and has received displayed Web page 56, which is one of a sequence of Web pages containing an embedded hyperlink to other Web pages.

Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53 which are linked 61 to the Web 50. The Web servers 53, which also may have the computer structure described with respect to FIG. 1, may be maintained by an ISP to the client's display terminal 57. The Web server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Internet 50 via linkage 61. The Web browser program 59 operates within the display terminals 57 to control the communication with the Web access server 53 to thereby download and display the accessed Web pages 56 on terminal 57. The Web access server 53 uses one of the previously described search engines 51 to access via the Web 50 the desired sequence of Web pages from appropriate Web resources such as databases 60 and 62. Web server 53 will carry out the functions of tracking, obtaining and storing (in cache 49) the bookmarked Web page changed versions as will be hereinafter described.

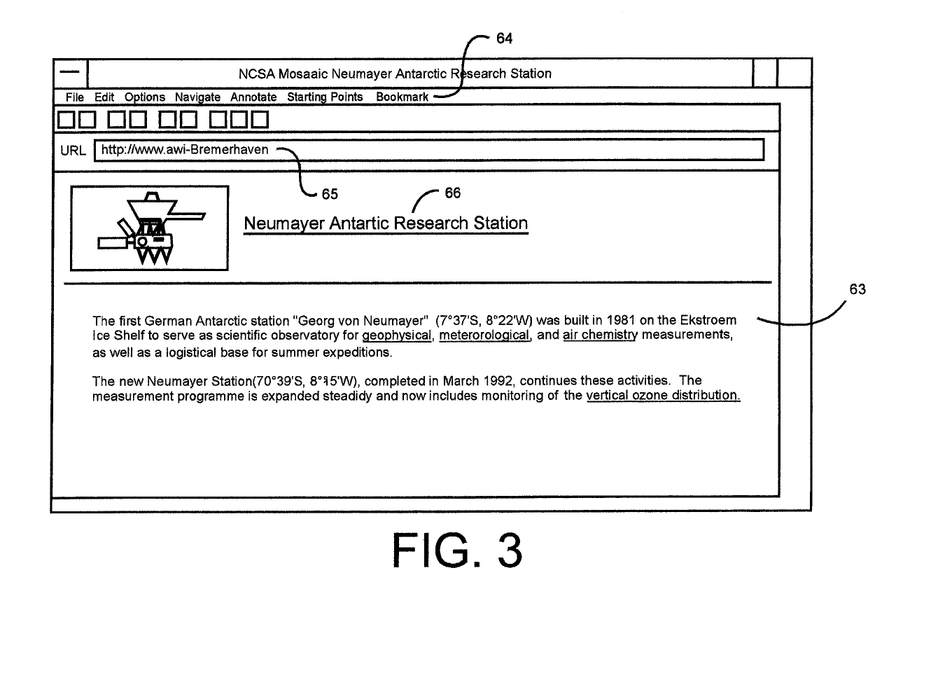

With this setup, the present invention, which will be described in greater detail with respect to FIGS. 3 through 7, may be carried out using Web browser 59 and associated Web server 53 (FIG. 2). Search engine 51 accesses the sequence of Web pages and provides such pages to the user at terminal 57 via Web browser 59 via server 53.

Now, with respect to FIGS. 3 through 7, we will provide an illustrative example of how the present invention may be used to provide for tracking of changed versions of bookmarked Web documents to be referred to as Web pages. Web page 63, FIG. 3, is an illustration of the displayed Web page 56 in FIG. 2. This standard page contains text, graphics and images, as well as hyperlinks to other Web documents. The Web page has a title 66. Also shown is the current URL 65 of the page. In the menu bar of the page is the conventional “Bookmark” item 64. When, as in the present example, the user selects to bookmark the document, and clicks on “Bookmark” 64, he is presented with a drop down dialog box menu 67 that initially offers the user the option of saving updates of the Web page. If the user selects No, he has no need to have updates, then the Web page is saved in the conventional manner by the browser, i.e. the path or URL to the page is saved as the bookmark. If, as here, the user wishes to have updates saved and clicks on Yes, he is requested by the menu dialog to select “How Frequently” 68 and then offered the selection of several time intervals 69. He is also asked to select the maximum number of updates to save 70 and has to scroll to that number in scroll window 71. That maximum number may be any number from “1” to “All”. Since this process is conducted through the Web server under the control of the ISP, the user's fees may be determined by his selections in items 69 and 71.

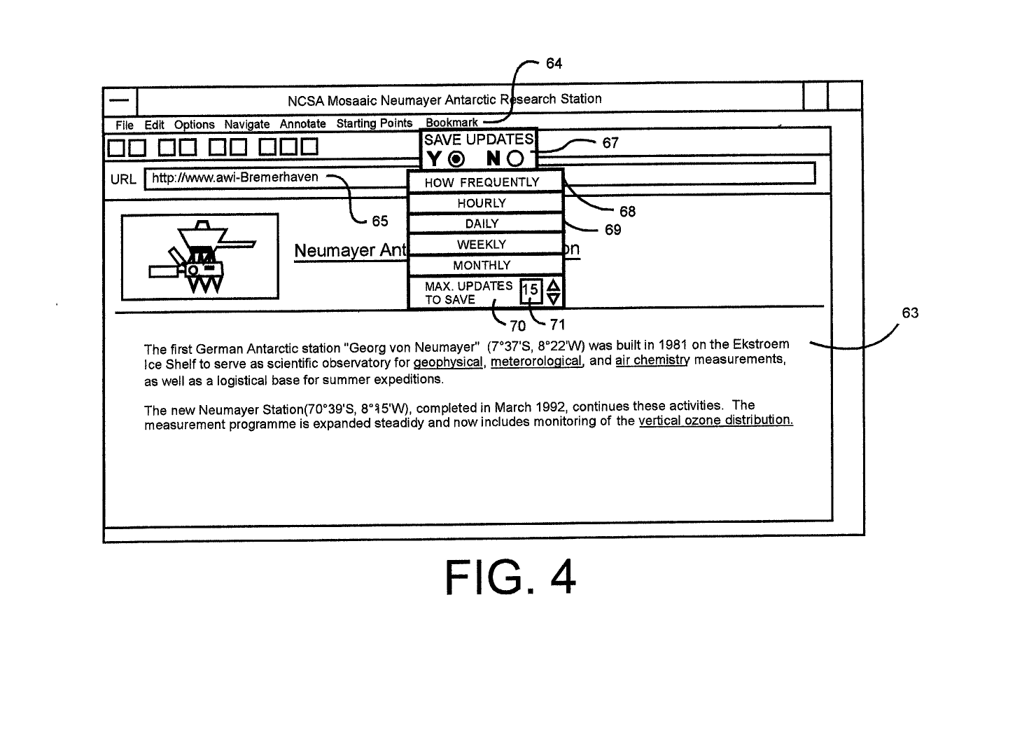

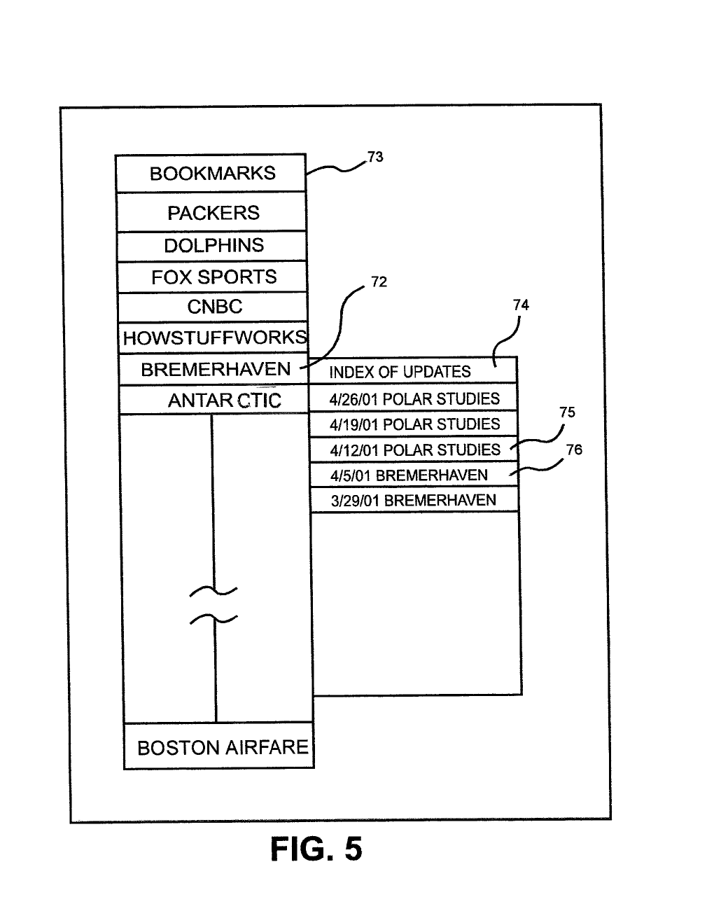

Assuming now that the user has made the choices shown in FIG. 4 with respect to Web page 63. Then, at some future date when he wishes to retrieve the bookmarked Web page, he is presented with the displayed menu of bookmarks 73, shown in FIG. 5, which is initially a conventional listing of his bookmarked documents. Should the user select a bookmarked item from this list for which he has chosen not to save updates, he will be presented with a conventional displayed Web page that will be the most current version of the Web page. He, of course, will not have an opportunity to see the original version of the page which he selected or any of its intermediate updates. Also, if the URL or location of the Web page has changed, it is likely that the user will not be branched to any new URL or consolidation of the page with another page at a new URL.

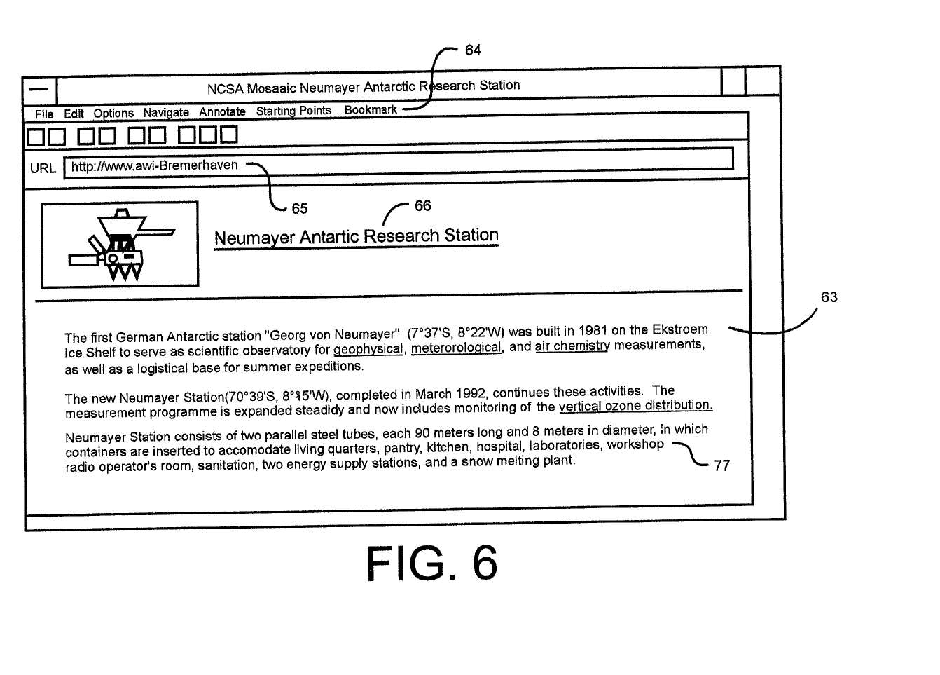

On the other hand where, as with our example, the user has chosen to have updates saved, then a selection of the bookmark 72 for the Web page will bring down menu Index of Updates 74 from which he may choose any of the five versions. Apparently, the user requested weekly updates in this example. The user's first section, item 76: “4/5/01 BREMERHAVEN” results in the Web page version of FIG. 6 to be displayed. This version still has the original title 66 and URL 65 but has some additional text 77.

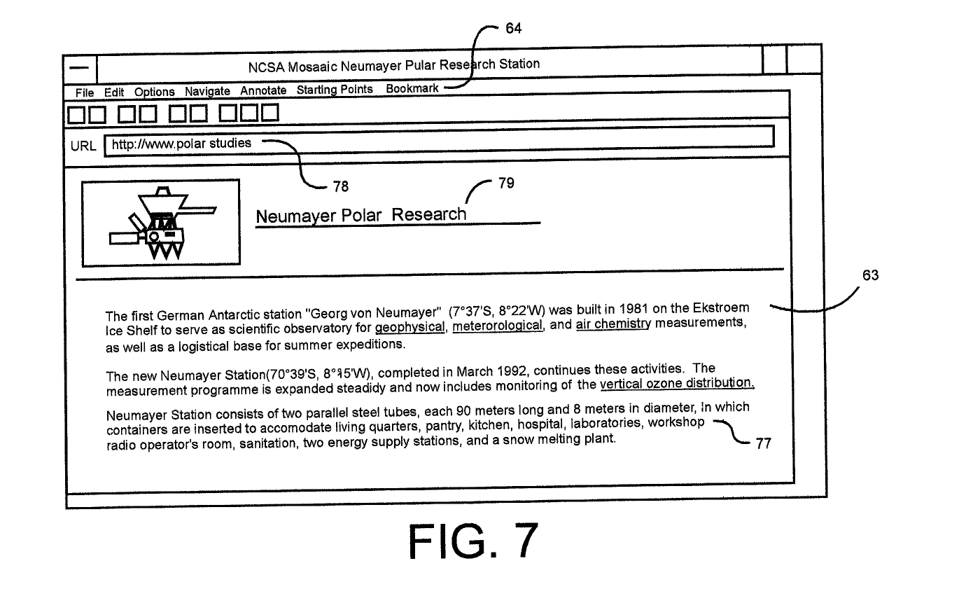

Should the user then select updated version item 75: “4/12/01 POLAR STUDIES” from Index 74, FIG. 5, then the updated Web page version shown in FIG. 7 will be displayed. In this version, in addition to additional text 77, there is a new title 79 and a changed URL 78. In this situation, it appears that the Web page has been consolidated with another Web page at another URL. However, the version updating has tracked and stored the changes. In this connection, it should be noted that when the URL of a Web page is changed for whatever reason, the Web page may leave a forwarding URL at the old location for a period of time. However, depending on the business significance of the moved page and/or how well the page is administered or managed, the time for forwarding may be relatively brief. The updates of the present invention are likely to be done with sufficient frequently to catch and record this URL forwarding information.

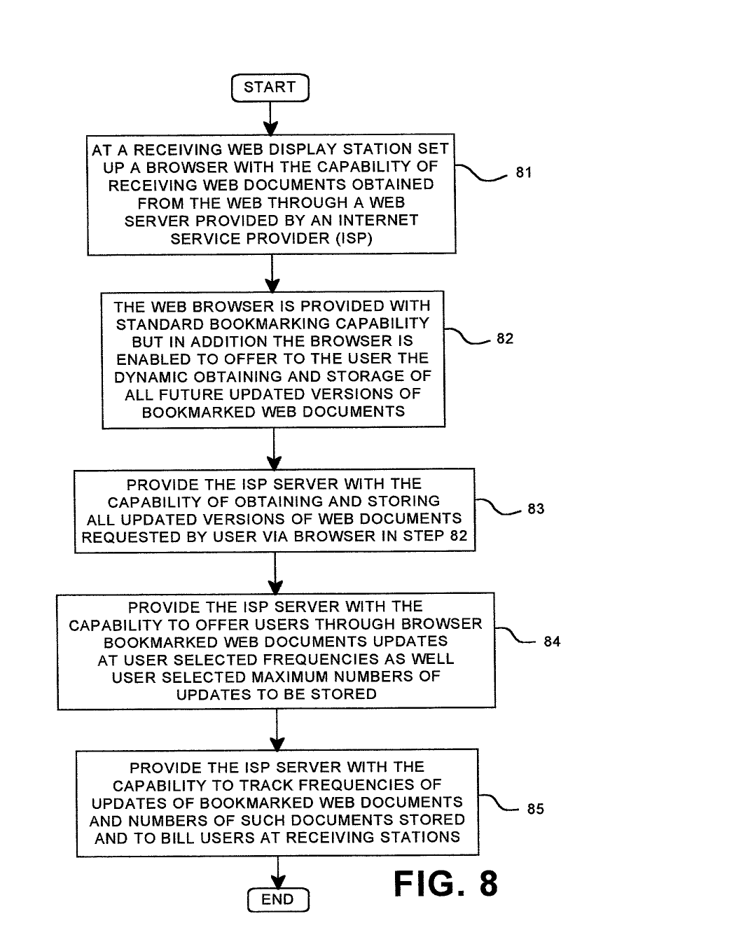

FIG. 8 is a flowchart showing the development of a process according to the present invention for tracking and storing updated versions of user selected received Web pages. Most of the programming functions in the process of FIG. 8 have already been described in general with respect to FIGS. 3 through 7. A Web browser is provided at a receiving display station on the Web for accessing Web pages in the conventional manner and loading them at the display station, step 81. The Web pages are conventionally obtained via a Web server provided by an ISP. The Web browser has the capability of requesting searches from one or more search engines available through the Web. A process is provided to give the Web browser standard bookmarking capabilities, but, in addition, the browser is enabled to offer to the user the dynamic obtaining and storing of up to all future updated versions of bookmarked Web documents, step 82. The ISP Web server for the receiving Web station is provided with the capability, step 83, of obtaining and storing up to all versions of the Web documents requested by the user in step 82. The ISP Web server is also provided with the capability to offer to users through the browser bookmarked document updates at a variety of user selected frequencies, as well as user selected maximum numbers of updates to be stored, step 84. The ISP Web server is provided with the capability to track such frequencies of updates of bookmarked documents, as well as the numbers of such updates obtained from the Web and stored and to bill the users at the receiving Web stations accordingly, step 85.

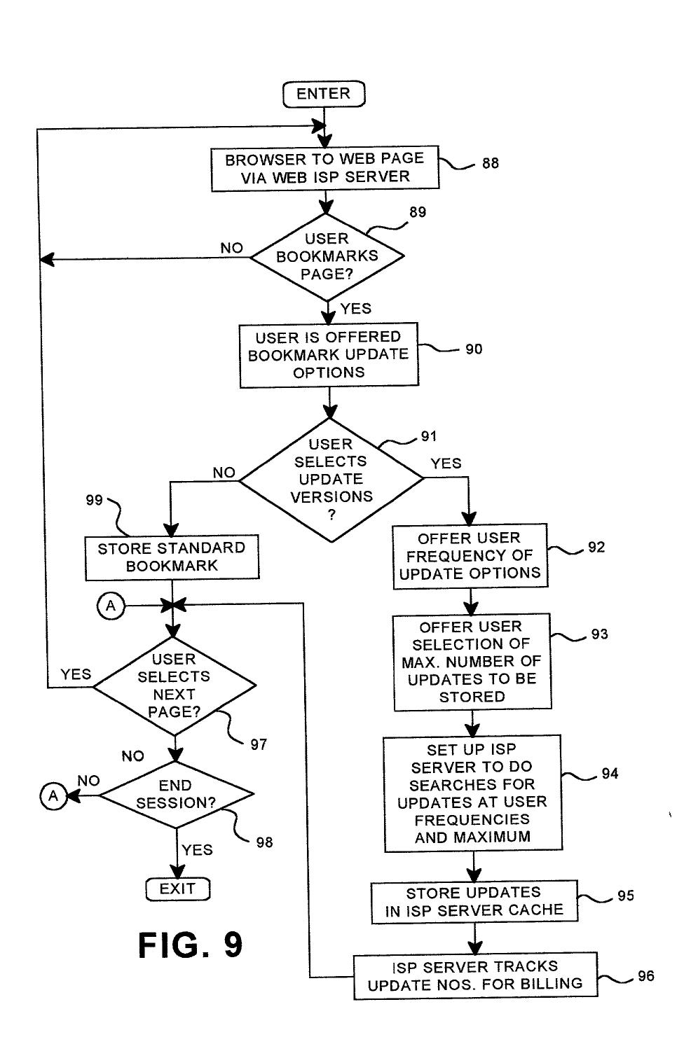

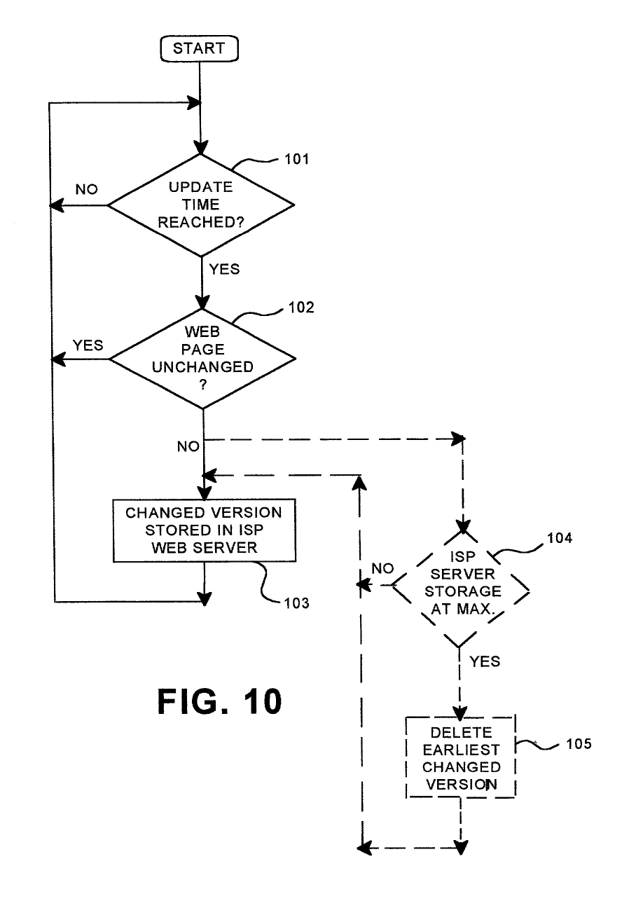

The running of the process set up in FIG. 8 and described in connection with FIGS. 3 through 7 will now be described with respect to the flowchart of FIG. 9. Let us assume that we are in a Web browsing session through the browser. The flowchart represents some steps in a routine that will illustrate the operation of the invention. The browser, via the ISP Web server, accesses the pages found by a search engine; the next Web page is accessed, step 88. A determination is made as to whether the user has bookmarked the page, step 89. If No, the process is returned to step 88 and the next page is awaited. If Yes, the user elects to bookmark the Web page, the user is offered the option of having future updated versions of the bookmarked page obtained and stored, step 90. If in decision step 91 the user decides not to obtain future versions of the Web page, then a standard bookmark is stored for the Web page, step 99. But if Yes, the user selects to have updated versions obtained and stored, the user is offered a dialog to select the frequency at which such updated versions are to be obtained, step 92, and to select the maximum number of such updated versions to be stored, step 93. The ISP Web server is then set up to do the periodic searches for upgrades at the selected frequencies, step 94, as will be described in greater detail with respect to FIG. 10, and to store only the maximum number of such updates selected to be stored.

The updated versions are then stored conveniently in the cache associated with the server, step 95. Storage capacity should not be a problem since the text may be stored in the HTML form. Whatever graphics there are in the Web page may stored in its standard system independent compressed format. Decompressing such compressed files to display graphics is summarized in the above-mentioned Internet: The Complete Reference, Milleniun Edition text, pp. 870-875. In any event, the graphics may be stored at high level API graphics calls conventionally used by the Web browser to display images.

The ISP server tracks the numbers of versions stored and the frequencies of updates for billing purposes, step 96. After steps 96 or 99, a determination is made as to whether the user has selected another page. If Yes, the process is returned to step 88 wherein the Web browser gets the next Web page. If No, another Web page is not requested, then, step 98, a determination is made as to whether the session is at an end. If Yes, the session is exited. If No, the process is returned to step 97 via branch “A” where the user selection of the next Web page is awaited.

Now, with respect to FIG. 10, we will describe a very general process of how the ISP Web server tracks the requested updates. First a determination is made as to whether the time for searching for an updated version has been reached according to the user selected frequency, step 101. If No, the process is returned to step 101, and that time is awaited. If Yes, a determination is made as to whether the Web page remains unchanged, step 102. If Yes, then there is no updated version to be stored and the process is returned to step 101 where the time for the next update search is reached.

There are two possibilities for a No decision from step 102: first, the Web page may indicate that it is a newer version and the date of the version. In such a case, if the Web page indicates a change, then the determination is No. Also, there are some Web pages that do not mark changed versions. In this case, we cannot assume that the Web page has not changed, i.e. the page is assumed to have been changed, thereby also resulting in a No decision from step 102. In the event of a No decision in step 102, i.e. it is likely that there has been a change in the Web page, then the version is stored in the ISP Web server cache, step 103, and the process is returned to step 101 where the next update time is awaited.

Thus far, the example has assumed that all changed versions are stored. However, as set forth above, the user may have set a maximum number of versions of the Web page to be saved. This variation is shown on FIG. 10 in dashed lines. Thus, after a No decision from decision step 102 indicative of a changed version, a determination is made, step 104, as to whether the ISP server storage has already reached the maximum set by the user. If No, then the process proceeds to step 103 as described above. If Yes, then, step 105, the earliest changed version is deleted, step 105, and the process proceeds to step 103 where the current version is stored in place of the deleted version. This procedure assumes that the user would like to have at least both the current version and the original version of the Web page. Of course, other combinations of saving and deletion may be combined to attain the maximum number of documents, i.e. the original version may be deleted and replaced with the current version or the current version may be discarded.

One of the preferred implementations of the present invention is in application program 40, i.e. a browser program made up of programming steps or instructions resident in RAM 14, FIG. 1, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a World Wide Web (“Web”) communication network with user access via a plurality of data processor controlled interactive receiving Web display stations for displaying received hypertext documents of at least one display page containing text and images accessible from sources on the Web, a system for selectively accessing any one of a historical sequence of changed versions of a Web document comprising:
means for bookmarking a received Web document;
means responsive to said bookmarking means for tracking for changed versions of said bookmarked document;
means for storing a historical sequence of versions of said bookmarked document; and
means, responsive to a user request at a receiving station for said bookmarked document, for enabling said user to select any one of said versions of said bookmarked document.

2. The Web system of claim 1 further including means enabling a user to selectively activate said tracking means.

3. The Web system of claim 1 wherein said means enabling the user to select any one of said versions of said bookmarked document comprise:
means for displaying the latest version of said bookmarked document; and
means for displaying an index of the other stored versions of said bookmarked document.

4. The Web system of claim 1 wherein said changed versions of said bookmarked documents include versions at changed URLs.

5. The Web system of claim 1 wherein said Web network includes a Web server; and
said Web server includes said means for tracking for said changed versions and means for storing said sequence of changed versions.

6. The Web system of claim 5 further comprising:
Web browsing means at said receiving display station including:
said means for bookmarking a received Web document; and
said means for enabling said user to select any one of said versions of said bookmarked document.

7. The Web system of claim 6 wherein said Web server is maintained by an Internet Service Provider.

8. The Web system of claim 7 further including means enabling the user to selectively vary the time intervals at which said changed versions of said bookmarked document are tracked for.

9. The Web system of claim 7 further including means enabling the user to selectively vary the maximum number of said sequence of changed versions of said bookmarked document are to be stored.

10. The Web system of claim 8 further including means enabling said Internet Service Provider to vary the charges to the user based upon the time intervals at which said changed versions of said bookmarked document are tracked for.

11. The Web system of claim 9 further including means enabling said Internet Service Provider to vary the charges to the user based upon the maximum number of said sequence of changed versions of said bookmarked document to be stored.

12. In a Web communication network with user access via a plurality of data processor controlled interactive receiving Web display stations for displaying received hypertext documents of at least one display page containing text and images accessible from sources on the Web, a method for selectively accessing any one of a historical sequence of changed versions of a Web document comprising:
bookmarking a received Web document;
tracking for changed versions of said bookmarked document;
storing a historical sequence of versions of said bookmarked document; and
responsive to a user request at a receiving station for said bookmarked document, enabling said user to select any one of said versions of said bookmarked document.

13. The method of claim 12 further including the step of enabling a user to selectively activate said tracking means.

14. The method of claim 12 wherein the step of enabling the user to select any one of said versions of said bookmarked document comprises the steps of:
displaying the latest version of said bookmarked document; and
displaying an index of the other stored versions of said bookmarked document.

15. The method of claim 12 wherein said changed versions of said bookmarked documents include versions at changed URLs.

16. The method of claim 12 wherein said Web network includes a Web server; and
said steps of tracking for said changed versions and storing said sequence of changed versions are carried out on said Web server.

17. The method of claim 16 further comprising:
a Web browsing process at said receiving display station including said steps of:
bookmarking a received Web document; and
enabling said user to select any one of said versions of said bookmarked document.

18. The method of claim 17 wherein said Web server is maintained by an Internet Service Provider.

19. The method of claim 18 further including the step of enabling the user to selectively vary the time intervals at which said changed versions of said bookmarked document are tracked for.

20. The method of claim 18 further including the step of enabling the user to selectively vary the maximum number of said sequence of changed versions of said bookmarked document that are to be stored.

21. The method of claim 19 further including the step of enabling said Internet Service Provider to vary the charges to the user based upon the time intervals at which said changed versions of said bookmarked document are tracked for.

22. The method of claim 20 further including the step of enabling said Internet Service Provider to vary the charges to the user based upon the maximum number of said sequence of changed versions of said bookmarked document that are to be stored.

23. A computer program having code recorded on a computer readable medium for selectively accessing any one of a historical sequence of changed versions of a Web hypertext document of at least one display page containing text and images, received at a Web display station, said program comprising:
means for bookmarking a received Web document;
means responsive to said bookmarking means for tracking for changed versions of said bookmarked document;
means for storing a historical sequence of versions of said bookmarked document; and
means, responsive to a user request at a receiving station for said bookmarked document, for enabling said user to select any one of said versions of said bookmarked document.

24. The computer program of claim 23 further including means enabling a user to selectively activate said tracking means.

25. The computer program of claim 23 wherein said means enabling the user to select any one of said versions of said bookmarked document comprise:
means for displaying the latest version of said bookmarked document; and
means for displaying an index of the other stored versions of said bookmarked document.

26. The computer program of claim 23 wherein said changed versions of said bookmarked documents include versions at changed URLs.

27. The computer program of claim 23 wherein said Web network includes a Web server; and
said Web server includes said program means for tracking for said changed versions and means for storing said sequence of changed versions.

28. The computer program of claim 27 further comprising:
a Web browser program at said receiving display station including:
said means for bookmarking a received Web document; and
said means for enabling said user to select any one of said versions of said bookmarked document.

29. The computer program of claim 28 wherein said Web server is maintained by an Internet Service Provider.

30. The computer program of claim 29 further including means enabling the user to selectively vary the time intervals at which said changed versions of said bookmarked document are tracked for.

31. The computer program of claim 29 further including means enabling the user to selectively vary the maximum number of said sequence of changed versions of said bookmarked document that are to be stored.

32. The computer program of claim 30 further including means enabling said Internet Service Provider to vary the charges to the user based upon the time intervals at which said changed versions of said bookmarked document are tracked for.

33. The computer program of claim 31 further including means enabling said Internet service Provider to vary the charges to the user based upon the maximum number of said sequence of changed versions of said bookmarked document that are to be stored.
